(19) United States
(12) Patent Application Publication
(10) Pub. No.: US 2026/0280142 A1
(43) Pub. Date: Sep. 17, 2026

(54) DENSIFIED MULTI-DIMENSIONAL MASSIVE MIMO UNIT

(71) Applicant: Samsung Electronics Co., Ltd., Suwon-si (KR)

(72) Inventors: Yunseong Cho, Frisco, TX (US); R A Nadisanka Perera Rupasinghe, McKinney, TX (US); Yang Li, Plano, TX (US); Jianzhong Zhang, Dallas, TX (US)

(21) Appl. No.: 19/078,082

(22) Filed: Mar. 12, 2025

(51) Int. Cl. H01Q 21/06; H01Q 1/12; H01Q 1/24; H01Q 23/00

(52) U.S. Cl. CPC H01Q 21/061; H01Q 1/1242; H01Q 1/1264; H01Q 1/246; H01Q 23/00

(57) ABSTRACT

An apparatus includes transmit receive point (TRP) antenna boards layered such that a front of each respective TRP antenna board faces the same direction. The apparatus includes at least one printed circuit board (PCB) including multiple antenna-facing sides on which the TRP antenna boards are attached, respectively. The apparatus includes front-end circuits that are attached to the at least one PCB and that are electrically coupled to the TRP antenna boards, respectively. Each of the TRP antenna boards includes a rear that is opposite to the front, a signal-propagation side, and a second side. The signal-propagation side includes a two-dimensional (2D) multiple-input multiple-output (MIMO) antenna array and extends from the front to the rear. The second side faces toward the at least one PCB, is opposite to the signal-propagation side, and extends from the front to the rear.

### TECHNICAL FIELD

This disclosure relates generally to wireless communication systems. More specifically, this disclosure relates to architecture and deployment of densified multi-dimensional massive multiple-input multiple-output (MIMO) unit.

### BACKGROUND

To further improve the performance of wireless communication systems, it is desirable to increase the number of available transceiver units. On the other hand, two adjacent antennas are anticipated to maintain a critical spacing of at least a half-wavelength to overcome the space correlation at two neighboring elements with regard to small-scale fading in deployment environments. Due to the aforementioned factors, increasing the number of antenna elements may be practically infeasible, as a result causing challenges in deployment.

### SUMMARY

This disclosure provides architecture and deployment of a densified multi-dimensional massive multiple-input multiple-output (MIMO) unit.

In one embodiment, an apparatus for deploying a densified multi-dimensional massive MIMO unit package is provided. The apparatus includes transmit receive point (TRP) antenna boards layered such that a front of each respective TRP antenna board faces the same direction. The apparatus includes at least one printed circuit board (PCB) including multiple antenna-facing sides on which the TRP antenna boards are attached, respectively. The apparatus includes front-end circuits that are attached to the at least one PCB and that are electrically coupled to the TRP antenna boards, respectively. Each of the TRP antenna boards includes a rear that is opposite to the front, a signal-propagation side, and a second side. The signal-propagation side includes a two-dimensional (2D) multiple-input multiple-output (MIMO) antenna array and extends from the front to the rear. The second side faces toward the at least one PCB, is opposite to the signal-propagation side, and extends from the front to the rear.

In another embodiment, a system for deploying a densified multi-dimensional massive MIMO unit package is provided. The system includes an antenna package and a reinforcement structure. The package includes transmit receive point (TRP) antenna boards layered such that a front of each respective TRP antenna board faces the same direction. The package includes at least one printed circuit board (PCB) including multiple antenna-facing sides on which the TRP antenna boards are attached, respectively. The package includes front-end circuits that are attached to the at least one PCB and that are electrically coupled to the TRP antenna boards, respectively. The package includes at least one heat sink attached to the at least one PCB. Each of the TRP antenna boards includes a rear that is opposite to the front, a signal-propagation side, and a second side. The signal-propagation side includes a two-dimensional (2D) multiple-input multiple-output (MIMO) antenna array and extends from the front to the rear. The second side faces toward the at least one PCB, is opposite to the signal-propagation side, and extends from the front to the rear.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIG. 2 illustrates an example gNodeB (gNB) according to this disclosure;

FIG. 3 illustrates an example two-dimensional massive multiple-input multiple-output unit (2D-MMU);

FIG. 4 illustrates an example double-sized 2D-MMU;

FIG. 5 illustrates an example three-dimensional massive multiple-input multiple-output unit (3D-MMU) according to this disclosure;

FIGS. 6A and 6B illustrate two examples of a deployment of three massive multiple-input multiple-output units (MMUs);

FIG. 6A illustrates an example deployment of three double-sized 2D-MMUs;

FIG. 6B illustrates an example deployment of three 3D-MMUs according to this disclosure;

FIG. 7 illustrates a system for deploying a densified multi-dimensional massive MIMO unit package according to this disclosure;

FIGS. 8A and 8B illustrate the system of FIG. 7 with components within the housing according to this disclosure;

FIG. 8C illustrates a top view of an embodiment of the 3D-MMU package of FIG. 8A that includes two single-sided PCBs with a fixed 180° facing angle difference according to this disclosure;

FIG. 9 illustrates a top view of a 2D-MMU package;

FIG. 10 illustrates a front view of a first embodiment of a 3D-MMU package that includes two single-sided PCBs according to this disclosure;

FIG. 11 illustrates a front view of a second embodiment of a 3D-MMU package that includes one double-sided PCB according to this disclosure;

FIG. 12 illustrates a front view of a third embodiment of a 3D-MMU package that includes two single-sided PCBs attached to a pivot joint to change a down-tilt angle according to this disclosure;

FIG. 13 illustrates a front view of a fourth embodiment of a 3D-MMU package that includes two single-sided PCBs and rows of TRP antennas that form a down-tilt angle according to this disclosure;

FIG. 14 illustrates a fifth embodiment of a 3D-MMU package that includes one double-sided PCB and rows of TRP antennas that form a down-tilt angle according to this disclosure;

FIG. 15 illustrates a top view of a sixth embodiment of a 3D-MMU package that includes two single-sided PCBs attached to a pivot joint to change a variable-facing angle according to this disclosure;

FIG. 16 illustrates a reinforcement structure that includes an upper reinforcement beam and a lower reinforcement beam respectively attached to a top end and a bottom end of the multi-dimensional MMU package of FIG. 7 according to this disclosure;

FIG. 17 illustrates a reinforcement structure that includes at least one side reinforcement beam attached to a rear of the multi-dimensional MMU package of FIG. 7 according to this disclosure;

FIG. 18 illustrates a pole tower cell site and an example deployment of three MMUs including two 3D-MMUs and one 2D-MMU according to this disclosure;

FIG. 19 illustrates a horizontal phase pipe of a lattice tower cell site and an example deployment of multiple 2D-MMUs including multiple 3D-MMUs according to this disclosure;

FIG. 20 illustrates a lattice tower cell site that includes multiple horizontal phase pipes and an example deployment of a 3D-MMU attached to a corner region of each of multiple horizontal phase pipes according to this disclosure;

FIG. 21 illustrates a lattice tower cell site that includes multiple horizontal phase pipes and an example deployment of a 3D-MMU attached to a middle of each of multiple horizontal phase pipes according to this disclosure; and

FIG. 22 illustrates a method for deploying a densified multi-dimensional MMU package according to this disclosure.

### DETAILED DESCRIPTION

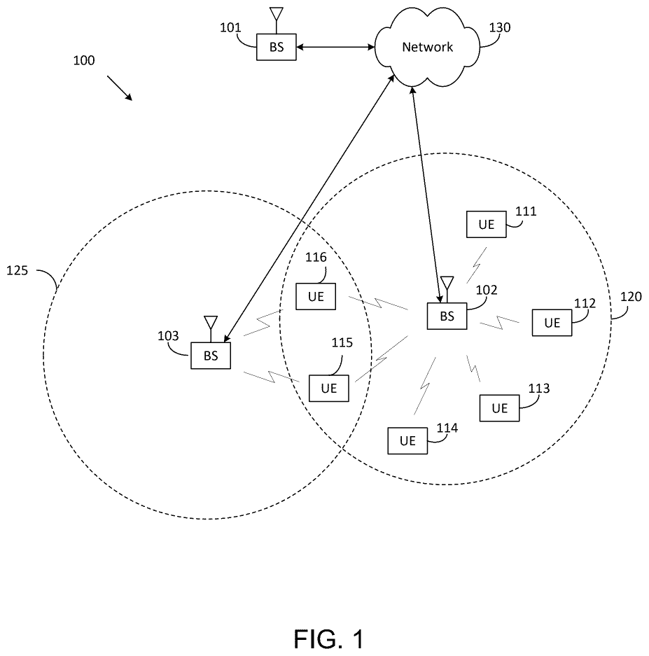

FIGS. 1 through 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication system or device.

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

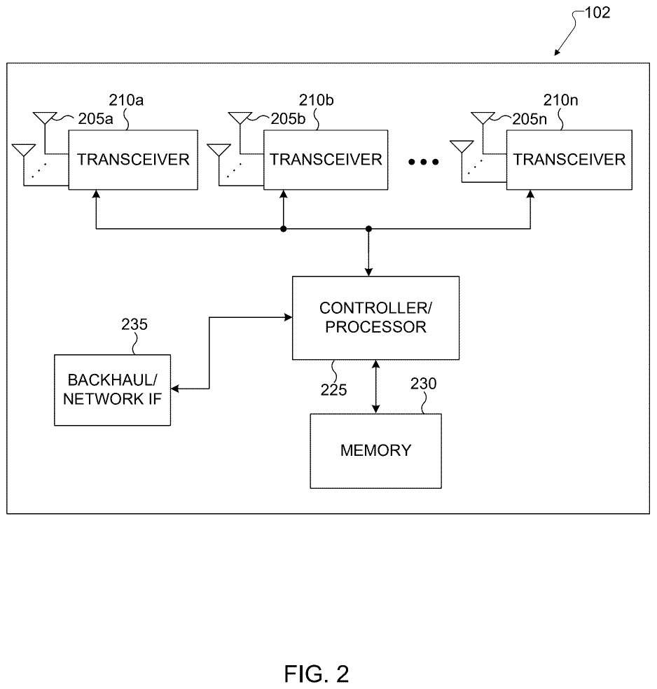

FIGS. 1 and 2 below describe various embodiments implemented in wireless communications systems and with the use of orthogonal frequency division multiplexing (OFDM) or orthogonal frequency division multiple access (OFDMA) communication techniques. The descriptions of FIGS. 1 and 2 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, the wireless network 100 supports deploying a densified multi-dimensional massive MIMO unit package.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

As described in more detail below, the gNB 102 is configured for deploying a densified multi-dimensional massive MIMO unit package.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

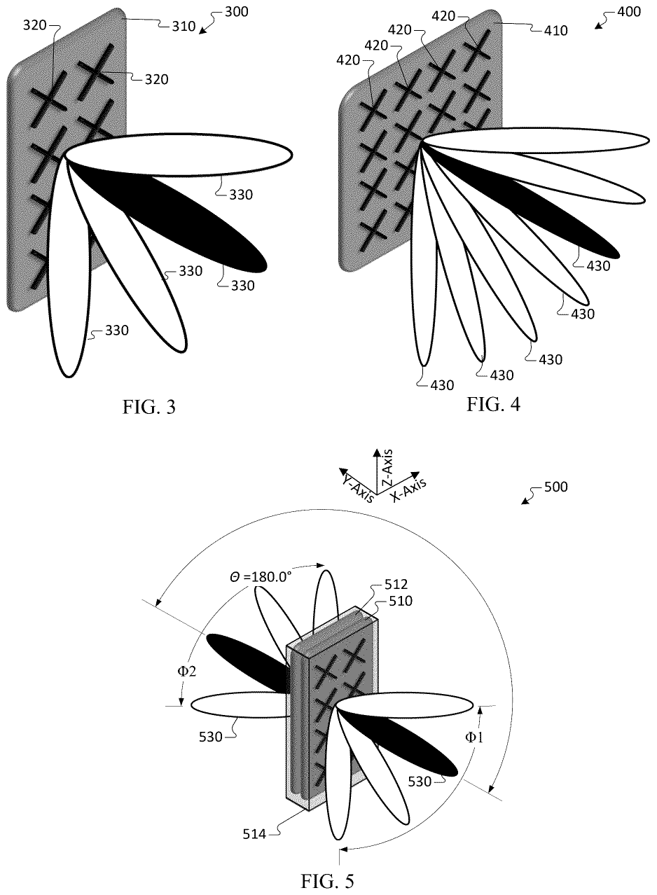

FIG. 3 illustrates an example two-dimensional massive multiple-input multiple-output unit (2D-MMU) 300. FIG. 4 illustrates an example double-sized 2D-MMU 400. FIGS. 3 and 4 will be described together. A shown, each 2D-MMU 300, 400 includes a transmit receipt point (TRP) 310, 410. The TRP includes a two-dimensional (2D) multiple-input multiple-output (MIMO) antenna array that includes multiple transceiver units (TXRUs) 320, 420 arranged in a rectangular array. In the case of the 2D-MMU 300, the rectangular array can include two columns and four rows. In the case of the double-sized 2D-MMU 400, the rectangular array can be a square array that includes four columns and four rows. The TXRUs 320, 420 are located on a front face of the 2D-MMU, which is referred to as a signal-propagation face from which the TXRUs 320, 420 emit radio frequency (RF) signals 330, 430.

Multi-user MIMO can be improved by increasing the number of ports in an MMU, however, the architecture of the MMU has restrictions. A first restriction is two adjacent ports are separated by a critical distance of a half-wavelength. In other words, two adjacent antennas are anticipated to maintain a critical spacing of at least a half-wavelength to overcome the space correlation at two neighboring elements with respect to small-scale fading in deployment environments. The architecture of the double-sized 2D-MMU 400 is designed using a horizontal expansion technique to increase the number of ports compared to the architecture of the 2D-MMU 300, and the architecture complies with this first restriction. A second restriction is that increasing the number of transceiver units (TXRUs) in the MMU may not be practically feasible and causes a challenge in deployment. For example, the horizontal expansion technique can be applied to the rudimentary TRP 310 to increase the number of TXRUs horizontally in order to produce the horizontal expanded TRP 410, which is a uniform-rectangular-array.

FIG. 5 illustrates an example three-dimensional massive multiple-input multiple-output unit (3D-MMU) 500 according to this disclosure. The embodiment of the 3D-MMU 500 shown in FIG. 5 is for illustration only, and other embodiments could be used without departing from the scope of this disclosure.

This disclosure provides details of the architecture and deployment of 3D-MMU that employs more TXRUs without increasing the horizontal dimension. The architecture of the 3D-MMU 500 is designed using back-to-back TRPs 510 and 512 in one 3D-MMU package 514. In other words, the first TRP 510 and the second TRP 512 are stacked in one 3D-MMU package 514. The pair of TRPs 510 and 512 maintain a certain difference in facing angle not to cause mutual coupling. In the example shown, the facing angle (O) is 180°, but other facing angles are possible in other embodiments without departing from the scope of this disclosure.

The pair of TRPs 510 and 512 create a pair of sectors, which can also be referred to as a pair of sub-cells. The first and second TRPs 510 and 512 emit one or more beams 530 according to a respective first radiation pattern and second radiation pattern, which can include a first and a second beamwidth angle Φ1 and Φ2, respectively.

The architecture of the 3D-MMU 500 complies with this first restriction, and increases the number of ports without increasing the horizontal dimension compared to the architecture of the 2D-MMU 300 (FIG. 3). In this example, the X-axis represents the horizonal dimension, while the Y-axis represents the thickness dimension. The difference in thickness between the 3D-MMU 500 and the 2D-MMU of FIG. 3 is less than the difference in horizontal width between the 3D-MMU 500 and the double-sized 2D-MMU 400 of FIG. 4.

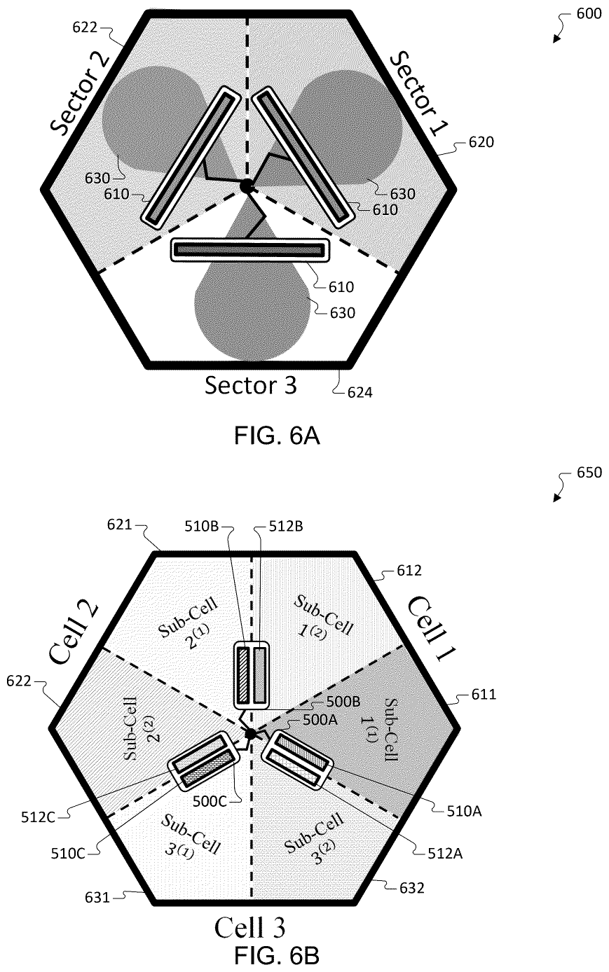

FIGS. 6A and 6B illustrate two examples of a deployment of three massive multiple-input multiple-output units (MMUs). FIG. 6A illustrates an example deployment 600 of three double-sized 2D-MMUs 610 forming a three-sectored cell. Each 2D-MMU 610 can represent the 2D-MMU 300 (FIG. 3) or the double-sized 2D-MMU 400 (FIG. 4). Each 2D-MMU 610 emits RF signals 630 into a different one of the Sectors 1-3 620, 622, and 624.

FIG. 6B illustrates an example deployment 650 of three 3D-MMUs according to this disclosure. Each of the three 3D-MMUs 500A-500C can represent the 3D-MMU 500 (FIG. 5). This deployment 650 of the three 3D-MMUs 500A-500C forms three cells (illustrated as Cell 1, Cell 2, and Cell 3) at a single cell site, and each cell is divided into a respective pair of sub-cells 611-612, 621-622, and 631-632. A first 3D-MMU 500A includes back-to-back TRPs 510A and 512A that emit RF signals into sub-cell 1⁽¹⁾ 611 and sub-cell 3⁽²⁾ 632, respectively. A second 3D-MMU 500B includes back-to-back TRPs 510B and 512B that emit RF signals into sub-cell 2⁽¹⁾ 621 and sub-cell 1⁽²⁾ 612, respectively. A third 3D-MMU 500C includes back-to-back TRPs 510C and 512C that emit RF signals into sub-cell 3⁽¹⁾ 631 and sub-cell 2⁽²⁾ 622, respectively.

The use of multiple packages in one particular cell and across cells (such as Cell 1 through Cell 3) unlocks the 3D-MMU architecture. This disclosure unveils various options for 3D-MMU package composition, which differ depending on electric components selected, such as printed circuit board (PCB), front-end board, and antenna elements. This disclosure substantiates how each 3D-MMU package can be mounted to each pipe of the cell site tower with reinforced structure, and how 3D-MMU packages can be deployed in each communication site.

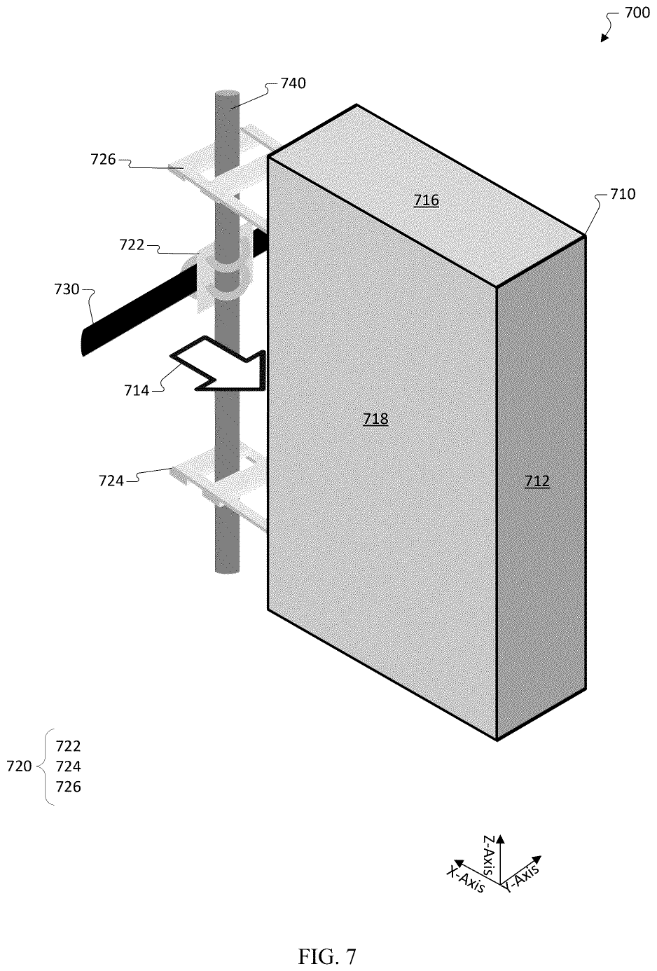

FIG. 7 illustrates a system 700 for for deploying a densified multi-dimensional massive MIMO unit package according to this disclosure. The system 700 includes a multi-dimensional MMU package 710 and a reinforcement structure 720. The embodiment of the system 700 shown in FIG. 7 is for illustration only, and other embodiments could be used without departing from the scope of this disclosure.

The multi-dimensional MMU package 710 can be the same as or similar to 3D-MMU package 514 of FIG. 5. The various faces of the multi-dimensional MMU package 710 includes a front 712, a rear (pointed to by an arrow 714, but not shown) opposite to the front 712, a top 716, a bottom (not shown) opposite to the top 716, and two sides 718 that are opposite to each other. For simplicity, reference number 714 also refers to rear face of the package 710. For example, the front 712 and rear 714 can be parallel to the y-z plane; the top 716 and bottom can be parallel to the x-y plane; and each of the sides 718 can be parallel to the x-z plane.

The reinforcement structure 720 includes at least one mounting clamp 722, 724, 726 configured to attach to a horizontal pipe 730 and to a vertical pole 740. In some embodiments, the reinforcement structure 720 includes the horizontal pipe 730 and the vertical pole 740, which can attach to a platform of a communication cell tower. In some embodiments, the horizontal pipe 730 is oriented parallel to the y-axis, and the vertical pole 740 is oriented parallel to the z-axis. A first mounting clamp 722 can be a U-bolt that structurally ties the horizontal pipe 730 to the vertical pole 740. A lower mounting clamp 724 and an upper mounting clamp 726 attach the package 710 to the vertical pole 740. That is, the reinforcement structure 720 includes at least one mounting clamp 724, 726 attached to the rear of the package 710 and configured to attach to the vertical pole 740, which is positioned facing the rear of the package 710. The lower mounting clamp 724 attaches to the rear 714 of the package 710 below and the upper mounting clamp 726 attaches to the rear of the package 710 above the horizontal pipe 730 and first mounting clamp 722.

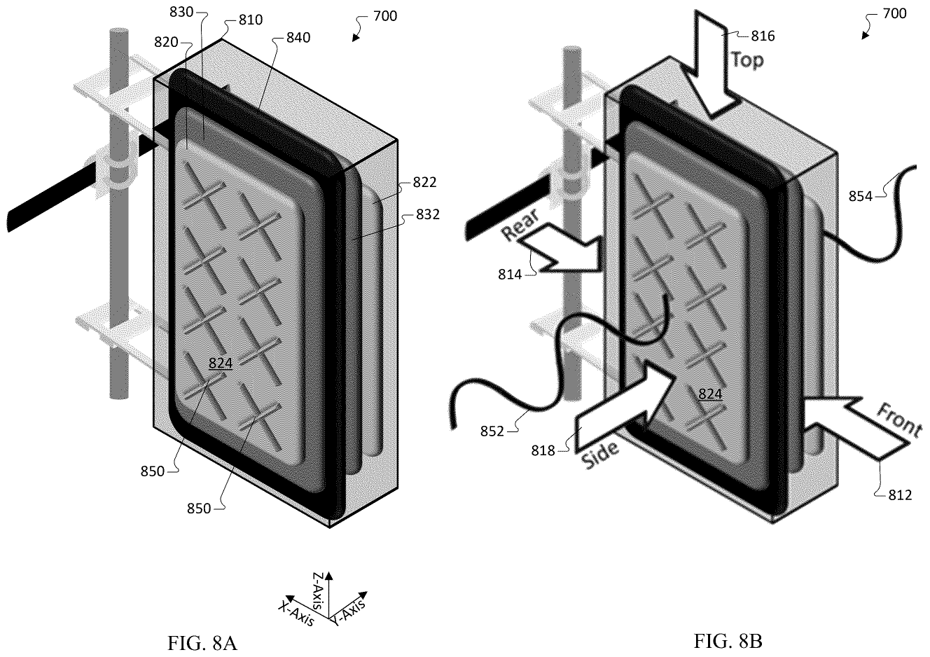

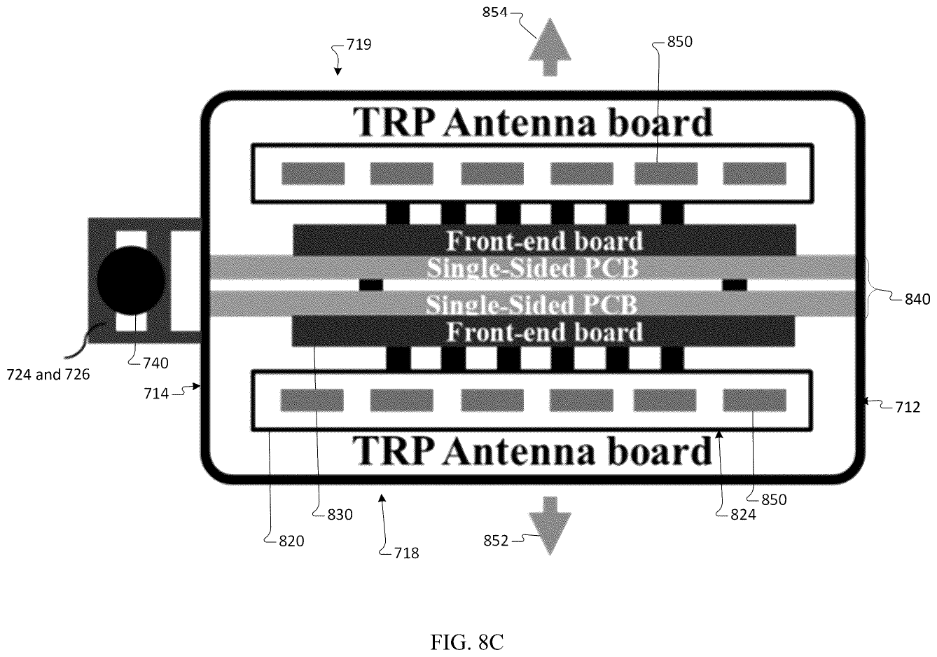

FIGS. 8A and 8B illustrate the system 700 of FIG. 7 with components within the housing 810 according to this disclosure. FIGS. 8A and 8B illustrate a perspective view of the system 700. That is, the package 710 (FIG. 7) includes a housing 810 that houses other components of the packet 710 within an interior space defined by exterior walls of the housing 810. The internal components within the housing 810 are described with reference to FIG. 8A. FIG. 8B includes a front arrow 812, rear arrow 814, a top arrow 816, and a side arrow 818 that respectively point the front 712, rear (not shown), top 716, and side 718 of the package 710, which define corresponding faces of the housing 810 and of the internal components. FIG. 8C illustrates a top view of an embodiment of the 3D-MMU package of FIG. 8A that includes two single-sided PCBs of with a fixed 180° facing angle difference according to this disclosure. FIG. 8C includes the rear 714 and the second side 719 of the package 710. The embodiment of the housing 810, TRP antenna boards 820 and 822, front-end circuits 830 and 832, and at least one printed circuit board (PCB) 840 shown in FIGS. 8A, 8B, and 8C (FIG. 8) is for illustration only, and other embodiments could be used without departing from the scope of this disclosure.

Each of the TRP antenna boards 820 and 822 functions as the interface between radio waves propagation and electric currents moving in the circuits (including front-end circuits 830 and 832 and circuits of the at least one PCB 840). Each of the TRP antenna boards 820 and 822 includes its own front that faces the same direction as the other TRP antenna boards 820 and 822. Each of the TRP antenna boards 820 and 822 includes its own rear that is opposite to the front of the TRP. Each of the TRP antenna boards 820 and 822 includes a signal-propagation side and a second side (not show) opposite to (facing an opposite direction than) the signal-propagation side. Each signal-propagation side includes a 2D MIMO antenna array that emits RF signals, such as multiple TXRUs 850 arranged in a 2×4 rectangular array. Each signal-propagation side extends from the front of the TRP antenna board (TRP) to the rear of the TRP antenna board, and so does each second side of the TRP antenna board. For example, the second side of the first TRP antenna board 820 faces the same direction that the side arrow 818 points and faces toward the at least one PCB 840. The side arrow 818 points to the signal-propagation side 824 of the first TRP antenna board 820. A first waveform 852 represents RF signals emitted by the TXRUs 850 located at the signal-propagation side 824 of the first TRP antenna board 820. The second TRP antenna board 822 is analogous to the first TRP antenna board 820, except facing an opposite direction such that a second waveform 854 represents RF signals emitted by the TXRUs 850 located at the signal-propagation side of the second TRP antenna board 820. The second waveform 854 represents RF signals emitted by the second TRP antenna board 820 in a different direction (for example, an opposite direction) than the first waveform 852.

The front-end circuits 830 and 832 are attached to the at least one PCB 840 and that are electrically coupled to the TRP antenna boards, respectively. In the example shown in FIG. 8A, each of the front-end circuits 830, 832 is a front-end board. The front-end board includes a series of analog signal processing circuits, which include power amplifiers, filters, and integrated circuits customized specifically for sensors, radio receivers, and other components. The front-end board serves as a versatile and adjustable electronic unit responsible for connecting different types of elements to an antenna, analog-to-digital converter (ADC), or sometimes even a microcontroller. The front-end board is wired onto a PCB, specifically, the at least one PCB 840. The front-end board is also physically connected to a TRP antenna board that includes multiple antenna elements (such as multiple TXRUs 850).

In the example shown, the front-end circuits 830 and 832 can also include a heat sink. In some embodiments, the front-end circuits 830 and 832 include a front-end board (such as a PCB) to which the power amplifier and filter are attached. The first front-end board is layered between the first TRP 820 and a first antenna facing side of the at least one PCB 840, while the second front-end board is layered between the second TRP 822 and a second antenna facing side of the at least one PCB 840.

The at least one PCB 840 can include a double-sided PCB or single-sided PCBs. The at least one PCB 840 includes multiple antenna-facing sides on which the TRP antenna boards 820 and 822 are attached, respectively.

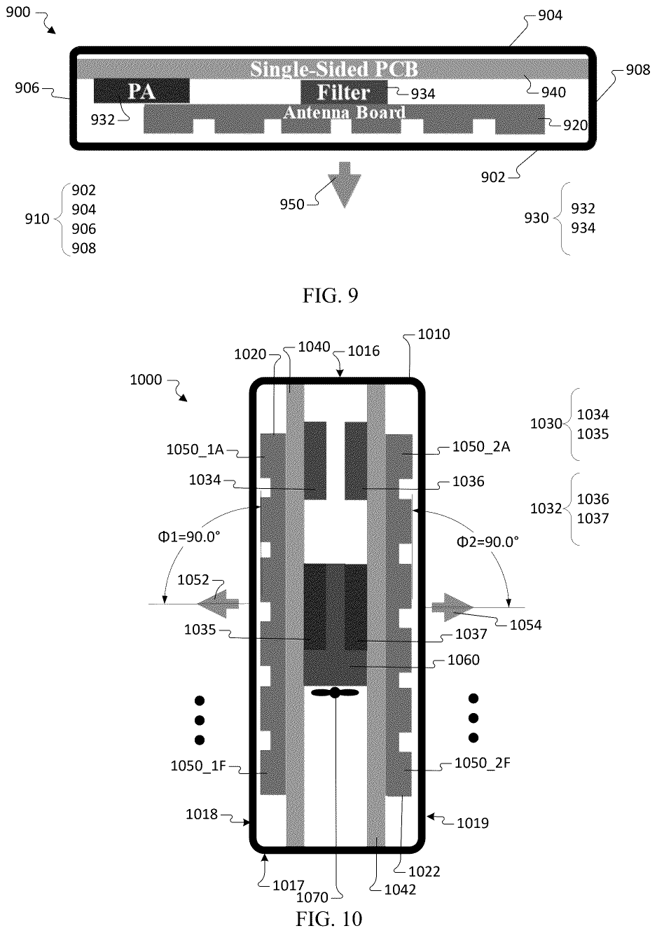

FIG. 9 illustrates top view of a 2D-MMU package 900, which can represent the 2D MMU package 300, 400, or 610 of FIG. 3, 4, or 6A. In this top view, the front 902, rear 904, first side 906, and second side 908 opposite to the first side 906 are visible. The 2D-MMU package 900 includes a housing 910 that includes an external wall defining the various faces 902, 904, 906, and 908. Within an internal space defined by the housing 910, the 2D-MMU package 900 includes one TRP antenna board 920, one front-end circuit 930 that includes a series of analog signal processing circuits including a power amplifier 932 and a filter 934, and one single-sided PCB 940.

The front-end circuit 930 is layered in front of the PCB 940 and behind the TRP antenna board 920 such that the power amplifier 932 and the filter 934 are positioned intermediately between the PCB 940 and antenna board 920. That is, the filter 934 and power amplifier 932 are wired onto the PCB 940. The TRP antenna board 920 is physically connected to the front-end board 930 while the antenna board 920 serves as the interface between radio waves propagation (in the direction 950).

The rear 904 of the 2D-MMU package attaches to the communication cell tower, enabling the TRP antenna board 920 to emit RF signals through the front 902 in the direction 950 of signal-propagation. For example, the direction 950 of signal-propagation can represent the direction in which the RF signals 630 are emitted from the 2D-MMU 610 of FIG. 6A.

FIGS. 8 and 10-16 illustrate variations of the 3D-MMU package 710 of FIG. 7, which can be designed by using different types of PCBs, filters, power amplifiers, TRP antennas, and a heat sink properly placed within the package. Many variations of 3D-MMU packaging can be realized by using different types of PCB, filter, PA, and TRP antenna. A heat sink has to be properly placed within the package.

FIG. 10 illustrates a front view of a first embodiment of a 3D-MMU package 1000 that includes two single-sided PCBs according to this disclosure. The embodiment of the 3D-MMU package 1000 shown in FIG. 10 is for illustration only, and other embodiments could be used without departing from the scope of this disclosure. The 3D-MMU package 1000 of FIG. 10 can represent the multi-dimensional MMU package 810 of FIG. 8.

The 3D-MMU package 1000 includes a housing 1010 that includes a front and rear, a top 1016, bottom 1017, a first side 1018, and a second side 1019. The housing 1010 can be the same as the housing 810 of FIG. 8. The 3D-MMU package 1000 includes first and second TRP antenna boards 1020 and 1022 that can be the same as the TRP antenna boards 820 ad 822 of FIG. 8. The 3D-MMU package 1000 includes front-end circuits 1030 and 1032.

Each TRP antenna board 1020, 1022 includes multiple TXRUs 1050 arranged in rows A through F, for example, first row 1050_1A through a last row 1050_1F, and a first row 1050_2A through a last row 1050_2F. The TXRUs 1050 of the first TRP 1020 emit RF signals in a first signal-propagation direction 1052, which can represent the first waveform 852. Similarly, TXRUs 1050 of the second TRP 1022 emit RF signals in a second signal-propagation direction 1054, which can represent the second waveform 854, in a different direction (for example, an opposite direction) than the first signal-propagation direction 1052. The first TRP 1020 interacts with actual RF wave propagation associated with the direction 1052; and the second TRP 1022 interacts with actual RF wave propagation associated with the direction 1054.

The 3D-MMU package 1000 includes two single-sided PCB 1040 and 1042, which can represent the at least one PCB 840 of FIG. 8. Each PCB 1040 and 1042 includes one antenna-facing side opposite to a non-conductive side of the PCB. That is, a conductive side of the first PCB 1040 faces toward and is electrically coupled to the first TRP 1020. The first front-end circuit 1030 includes a filter 1034 and power amplifier 1035 coupled to the non-conductive side of the first PCB 1040.

Similarly, the conductive side of the second PCB 1042 is electrically coupled to the second TRP 1022, and the non-conductive side is attached to the second front-end circuit 1032 that includes the filter 1036 and power amplifier 1037. In some embodiments, the two PCBs 1040 and 1042 are bonded where each PCB 1040, 1042 holds a single front-end board.

Both front-end circuits 1030 and 1032 share this single front-end board, in a similar way that both share a heat sink 1060. The heat sink 1060 forms a layer between the non-conductive sides of the two PCBs 1040 and 1042 to provide cooling. The thickness of the heatsink 1060 can be the separation distance between the non-conductive sides of the two PCBs 1040 and 1042. The cross-section of the heat sink 1060 can have an upside-down T shape, where the vertical portion of the T-shape forms a layer between the two power amplifiers 1035 and 1037. Both power amplifiers 1034 and 1036 and both PCBs 1040 and 1042 are cooled by a shared heat sink fan 1070 in the middle. That is, the fan 1070 can be located to blow air between the non-conductive sides of the two PCBs 1040 and 1042 and in a vertical direction across the heat sink 1060.

Although FIG. 10 illustrates a first embodiment of a 3D-MMU package 1000, some features of the 3D-MMU package 1000 are common to all of the variations of the 3D-MMU package illustrated in FIGS. 10-16. For example, the mutual coupling between the two TRP antenna boards in each 3D-MMU package is marginal because each TRP antenna board is configured to direct toward a horizontal radiation pattern that is between 60° and 120°. In other words, each of the first and second signal-propagation directions 1052 and 1054 forms an angle Φ1 and Φ2 relative to a vertical plane (such as the y-z plane, or a plane defined in part by the vertical pole 740 of FIG. 7). As a set of parameters, these horizontal radiation pattern angles Φ1 and Φ2 are set to avoid a threshold level of mutual coupling. In FIG. 10, the respective signal-propagation sides of the package TRPs 1020 and 1022 are parallel to the vertical axis, and the first and second sides 1018 and 1019 of the 3D-MMU package are parallel to the vertical axis, because there is no down-tilt. However, in other embodiments, the vertical axis is parallel to the first and second sides 1018 and 1019 of the 3D-MMU package while the signal-propagation sides of the TRPs form a down-tilt angle with respect to the vertical axis.

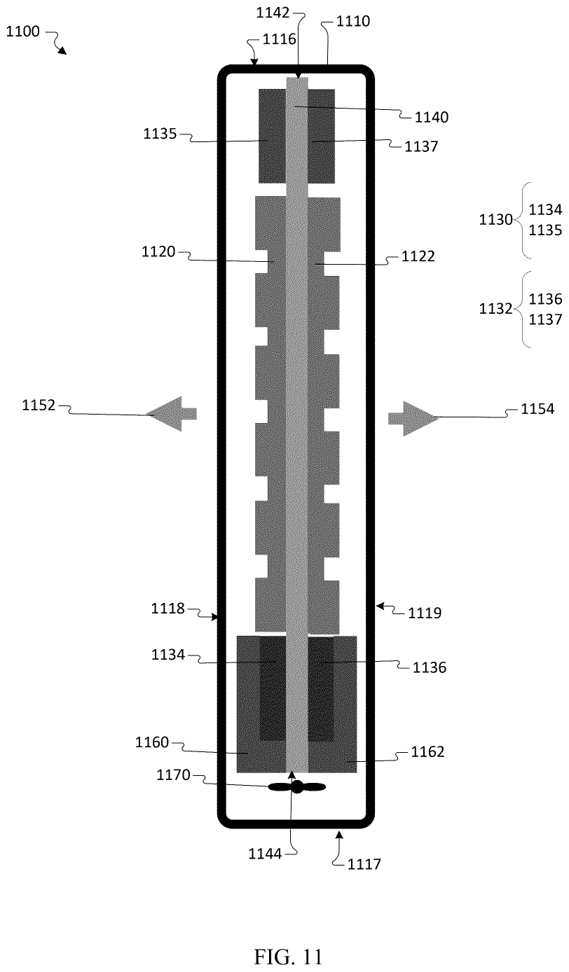

FIG. 11 illustrates a front view of a second embodiment of a 3D-MMU package 1100 that includes one double-sided PCB 1140 according to this disclosure. The embodiment of the 3D-MMU package 1100 shown in FIG. 11 is for illustration only, and other embodiments could be used without departing from the scope of this disclosure.

The 3D-MMU package 1100 of FIG. 11 can represent the multi-dimensional MMU package 710 of FIG. 8. The orientation of the 3D-MMU package 1100 of FIG. 11 is the same as the front view of FIG. 10, so the top 1116, bottom 1117, a first side, 1118, and a second side 1119 of the housing 1110 of FIG. 11 can be the same as or similar to the corresponding faces 1016, 1017, 1018, and 1019 of the housing 1010 in FIG. 10.

Among the internal components of the 3D-MMU package 1100, one double-sided PCB 1140 is located at the center of the 3D-MMU package 1100, and can represent the at least one PCB 840 of FIG. 8. This bidirectional PCB 1140 electrically connects to two front-end circuits 1130 and 1132, thereby saving weight because the PCB is one of the heaviest components in the MMU. As a comparison, the internal components of the 3D-MMU package 1100 weigh less than double the weight of the 2D-MMU 900 of FIG. 9 because the weight of a PCB (such as the single sided PCB) is one of the heaviest components in any MMU.

The first front-end circuit 1130 includes a filter 1134 and power amplifier 1135 coupled to a first conductive side of the PCB 1140. The second front-end circuit 1132 includes a filter 1136 and power amplifier 1137 coupled to a second conductive side of the PCB 1140. Along the thickness dimension (Y-axis), the double-sided PCB 1140 is layered between the front-end circuits 1130 and 1132.

Each power amplifier 1135 and 1137 is positioned between the TRP antenna board and one from among a top end 1142 and a bottom end 1144 of the PCB 1140. In the example shown, the power amplifiers 1135 and 1137 are positioned between a top end of the TRP antenna boards 1120 and 1122 and the top end 1142 of the PCB 1140.

Each filter 1134 and 1136 is positioned between the TRP antenna board and the other from among the top and bottom ends 1142 and 1144 of the PCB 1140. In the example shown, the filters 1134 and 1136 are positioned between a bottom end of the TRP antenna boards 1120 and 1122 and the bottom end 1144 of the PCB 1140.

Two heatsinks 1160 and 1162 are located where each provides cooling to a different one of the conductive sides of the PCB 1140. Along the thickness dimension (Y-axis), each power amplifier 1135 and 1137 is layered between the PCB 1140 and a respective heatsink 1160 and 1162. The fan 1170 blows air in a vertical direction across the tow heatsinks 1160 and 1162, and can be the same as or similar to the fan 1070 of FIG. 10.

The TXRUs of the first and second TRPs 1120 and 1122 emit RF signals in a first signal-propagation direction 1152 and a second signal-propagation direction 1154, respectively. There is no down-tilt in the 3D-MMU package 1100, the respective signal-propagation as sides of the first and second TRPs 1120 and 1122 are parallel to the vertical axis.

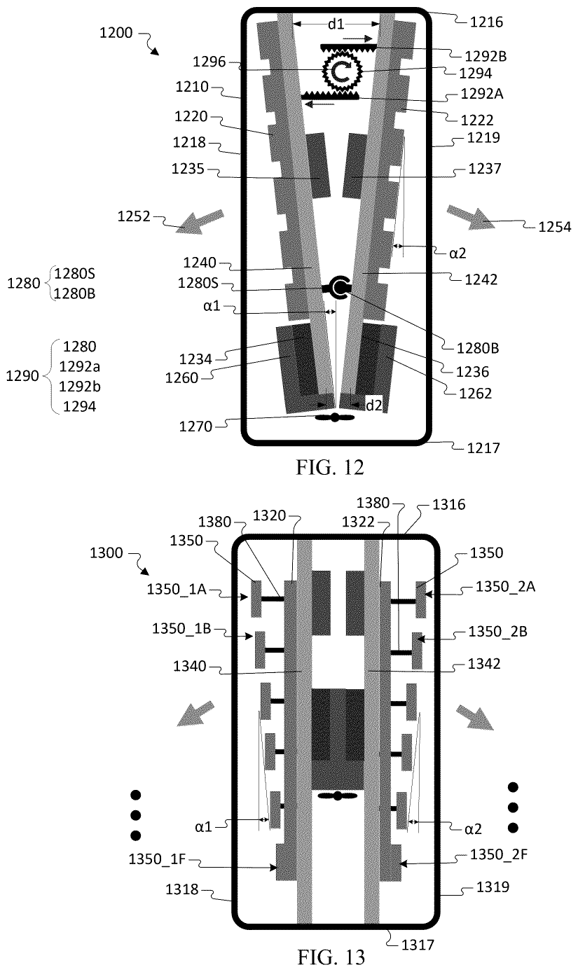

FIG. 12 illustrates a front view of a third embodiment of a 3D-MMU package 1200 that includes two single-sided PCBs 1240 and 1242 attached to a pivot joint 1280 to change a down-tilt angle according to this disclosure. The embodiment of the 3D-MMU package 1200 shown in FIG. 12 is for illustration only, and other embodiments could be used without departing from the scope of this disclosure.

The orientation of the 3D-MMU package 1200 of FIG. 12 is the same as the front view of FIG. 10, so the top 1216, bottom 1217, a first side, 1218, and a second side 1219 of the housing 1210 of FIG. 12 can be the same as or similar to the corresponding faces 1016, 1017, 1018, and 1019 of the housing 1010 in FIG. 10.

The 3D-MMU package 1200 includes two single-sided PCBs 1220 and 1222 that can represent the at least one PCB 840 of FIG. 8A. The 3D-MMU package 1200 includes two power amplifiers 1234 and 1236, two heat sinks 1260 and 1262, and a fan 1270 that can be the same as the corresponding components 1134, 1136, 1160, 1162, 1170 shown in the FIG. 11. That is, each PCB 1220, 1222 employs a separate set of a front-end board and a TRP antenna board.

The 3D-MMU package 1200 includes two filters 1235 and 1237 attached to the non-conductive sides of the two single-sided PCBs 1220 and 1222, respectively. That is, the front-end circuitry can have a filter 1235 on a different side of a PCB 1240 than a power amplifier 1234.

The 3D-MMU package 1200 includes a down-tilting mechanism 1290, which can be part of the upper mounting clamp 726 of FIG. 7, enabling a designer to specify a vertical down-tilt angle α within the package 1200. The down-tilt angle α can be measured relative to a vertical axis (such as the z-axis). The tunable down-tilt mechanism 1290 controls the vertical down-tilt angles α1 and α2 of the respective PCBs 1240 and 1242 to match the specified vertical down-tilt angle α. The down-tilt mechanism 1290 is located in the middle between the PCBs 1240 and 1242. More particularly, the down-tilting mechanism 1290 includes the pivot joint 1280, a pair of sliding gear racks 1292a and 1292b respectively attached to the non-conductive sides of the PCBs 1240 and 1242, and a rotating gear 1294 that moves along the sliding gear racks. The rotating gear 1294 can be rotated by a motorized force, or by a mechanical linkage that translates manual force into torque. The rotating gear 1294 can rotate in a clockwise direction 1296 to increase a separation distance d1 between top ends of the two PCBs 1240 and 1242, and can rotate in a counterclockwise direction to decrease the separation distance d1.

The pivot joint 1280 configured to decrease a second separation distance d2 between bottom ends of the two single-sided PCBs 1240 and 1242 while the separation distance d1 between the top ends of the two single-sided PCBs increases. That is, rotation of the rotating gear 1294 can modify the second separation distance d2 within a range of distances such that a mechanical limit of the pivot joint 1280 mechanically prevents the bottom ends of the two single-sided PCBs from contacting each other. The pivot joint 1280 can be a ball and socket joint, hinge, or another type of pivot joint. The non-conductive sides of each of the two PCBs 1240 and 1242 are respectively attached to the socket part 1280S and the ball part 1280B of the pivot joint 1280.

The TXRUs of the first and second TRPs 1220 and 1222 emit RF signals in a first signal-propagation direction 1252 and a second signal-propagation direction 1254, respectively. The horizontal radiation pattern angles associated with the directions 1252 and 1254 are oriented vertically downward according to the down-tilt angles α1 and α2, compared to the horizontal radiation pattern angles Φ1 and Φ2 of FIG. 10 that are not down-tilted (namely, associated with a down-tilt angle α=0 or is parallel to the vertical axis).

FIG. 13 illustrates a front view of a fourth embodiment of a 3D-MMU package 1300 that includes two single-sided PCBs and rows of TRP antennas that form a down-tilt angle according to this disclosure. The embodiment of the 3D-MMU package 1300 shown in FIG. 13 is for illustration only, and other embodiments could be used without departing from the scope of this disclosure.

The orientation of the 3D-MMU package 1300 of FIG. 13 is the same as the front view of FIG. 10, so the top 1316, bottom 1317, a first side 1318, and a second side 1319 of the housing of FIG. 13 can be the same as or similar to the corresponding faces 1016, 1017, 1018, and 1019 of the housing in FIG. 10. The two single-sided PCBs 1040 and 1042, front-end circuitry 1032 and 1032, heatsink 1060, and fan 1070 of FIG. 10 are included in 3D-MMU package 1300 of FIG. 13. The down-tilt angles α1 and α2 of FIG. 13 can be the same as or similar to the corresponding angles α1 and α2 of FIG. 12.

The 3D-MMU package 1300 includes first and second TRP antenna boards 1320 and 1322, which can be identical to each other. Within the 2D MIMO antenna array of the first TRP antenna board 1320, multiple TRP antennas (such as TXRUs) 1350 are arranged in rows A through F 1350_1A through 1350_1F. The second TRP antenna board 1322 includes multiple TRP antennas 1350 arranged in rows A through F 1350_2A through 1350_2F.

The first TRP antenna board 1320 includes connecting bars (connecting wires) 1380 that extend from the rows 1350_1A through 1350_1F of TRP antennas 1350, respectively, to the antenna-facing side of the first PCB 1320 to which the respective TRP antenna board 1320 is attached. Similarly, the second TRP antenna board 1322 includes connecting wires 1380 that extend from the rows 1350_2A through 1350_2F of TRP antennas 1350, respectively, to the antenna-facing side of the second PCB 1342 to which the respective TRP antenna board 1322 is attached. The connecting wires 1380 extend proportional distances such that the rows of TRP antennas 1350 form a down-tilt angle α1 and α2 of the respective TRP antenna board 1320, 1322. Among the set of connecting wires 1380 associated with the first TRP 1320 and first PCB 1340, the connecting wires 1380 of row A 1350_1A extend farthest, and the connecting wires 1380 of row F 1350_1F extend shortest (if at all). Similarly, the connecting wires 1380 of row A 1350_2A and of row F 1350_2F respectively extend farthest and shortest, among the set of connecting wires 1380 associated with the second TRP 1322 and second PCB 1342.

As a comparison, the connecting wires 1380 are located between front-end board 1320 and each TRP antenna 1350 (or each row A-F). However, the down-tilting mechanism 1290 of FIG. 12 is located between the two single sided PCBs 1240 and 1242. As another comparison, each connecting wire 1380 is extended such that TRP antennas 1350 can form a unique vertical down-tilt angle α. However, the down-tilting mechanism 1290 of FIG. 12 moves all of the TXRUs 1250 in unison with movement of the PCB and TRP boards 1320 and 1340. The 3D-MMU 1300 provides the ability to control the connecting wire 1380 extension of each row of TRP antennas, which provides greater granularity of control of the down-tiling angle α. An embodiment in which the connecting wire 1380 extension of each TRP antenna 1350 can be adjusted provides even more granularity of control of the down-tiling angle α.

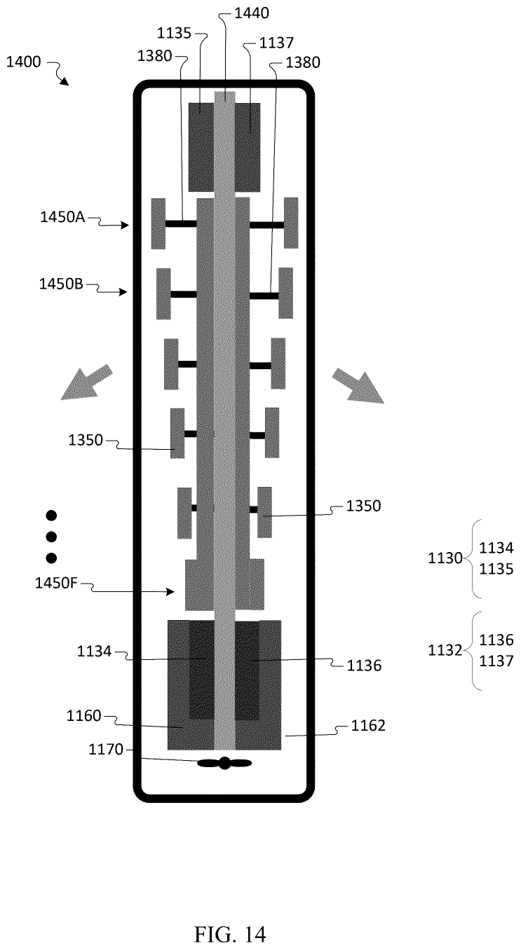

FIG. 14 illustrates a fifth embodiment of a 3D-MMU package 1400 that includes one double-sided PCB and rows 1450A-1450F of TRP antennas that form a down-tilt angle according to this disclosure. The 3D-MMU package 1400 is similar to the 3D-MMU 1300 of FIG. 13, except for 3D-MMU package 1400 includes a double-sided PCB 1440 to reduce the weight instead of two single-sided PCBs. As another exception, the 3D-MMU package 1400 includes the front-end circuits 1130 and 1132, heatsink 1160, and fan 1170 of FIG. 11 instead of the corresponding components of FIGS. 13 and 10. The embodiment of the 3D-MMU package 1400 shown in FIG. 14 is for illustration only, and other embodiments could be used without departing from the scope of this disclosure.

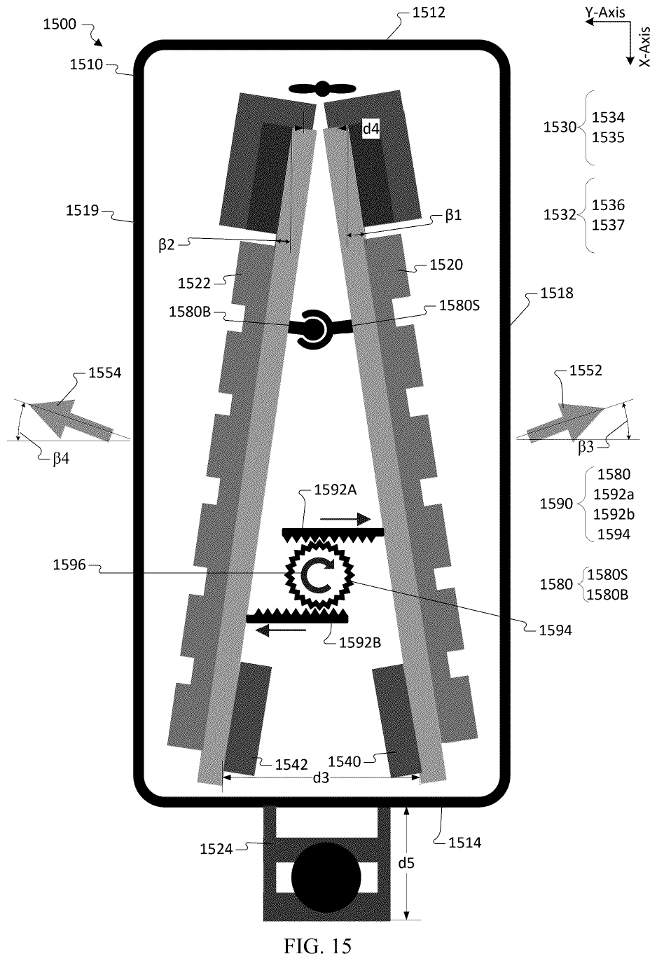

FIG. 15 illustrates a top view of a sixth embodiment of a 3D-MMU package 1500 that includes two single-sided PCBs 1540 and 1542 attached to a pivot joint 1580 to change a variable-facing angle ↓ according to this disclosure. The embodiment of the 3D-MMU package 1500 shown in FIG. 15 is for illustration only, and other embodiments could be used without departing from the scope of this disclosure.

The housing 1510 includes a top and bottom, front 1512, rear 1514, first side 1518, second side 1519 of the housing 1510. The housing 1510 can be the same as the housing 810 of FIG. 8.

The 3D-MMU package 1500 includes first and second TRP antenna boards 1520 and 1522, which can be the same as the corresponding components 1220 and 1222 of FIG. 12. The two TRPs 1520 and 1522 do not necessarily maintain an exact 180-degree difference in facing angle (↓) of the 3D-MMU 1500. This is compared to the fixed facing angle ↓=180° in FIGS. 5, 10, and 13. It is also possible to specify a variable facing angle (↓) by installing a variable mechanism 1590 between the two single-sided PCBs 1530 and 1532.

The variable mechanism 1590 operates in a similar manner as the down-tilting mechanism 1290 of FIG. 12, except the variable mechanism 1590 controls the individual facing angles β1 and β2 of the respective PCBs 1540 and 1542 with respect to a horizontal axis (parallel to x-axis). The relative facing angle θ between the two the antenna-facing sides of the two PCBs 1540 and 1542 is determined by the individual facing angles β1 and β2.

The variable mechanism 1590 includes the pivot joint 1580, a pair of sliding gear racks 1592a and 1592b respectively attached to the non-conductive sides of the PCBs 1540 and 1542, and a rotating gear 1594 that moves along the sliding gear racks. The rotating gear 1594 can be rotated by a motorized force, or by a mechanical linkage that translates manual force into torque. The rotating gear 1594 can rotate in a clockwise direction 1596 to increase a third separation distance d3 between rear ends of the two PCBs 1540 and 1542, and can rotate in a counterclockwise direction to decrease the third separation distance d3. The rotating gear 1594 can be rotated by a motorized force, or by a mechanical linkage that translates manual force into torque.

The non-conductive sides of each of the two PCBs 1540 and 1542 are respectively attached to the socket part 1580S and the ball part 1580B of the pivot joint 1580. The pivot joint 1580 can attach to a location near the front end of the PCB (also near the front 1512 of the packet), in comparison to the pivot joint 1280 of FIG. 12 that attaches to a location near the bottom end of the PCB (also near the bottom 1217 of the packet). The pivot joint 1580 is configured to decrease a fourth separation distance d4 between front ends of the two single-sided PCBs 1540 and 1542 while the third separation distance d3 between the rear ends of the two single-sided PCBs increases. That is, rotation of the rotating gear 1594 can modify the fourth separation distance d4 within a range of distances such that a mechanical limit of the pivot joint 1580 mechanically prevents the front ends of the two single-sided PCBs from contacting each other.

The TXRUs of the first and second TRPs 1520 and 1522 emit RF signals in a first signal-propagation direction 1552 and a second signal-propagation direction 1554, respectively. The first and second signal-propagation directions 1552 and 1554 bisect a beam width defined by the horizontal radiation pattern angles Φ1 and Φ2. The first and second signal-propagation directions 1552 and 1554 are shown at angles β3 and β4 relative to a vertical plane (such as the y-z plane). In the example shown, the angles β3 and β4 are not parallel to the vertical plane (β3>0<β4), the variable-facing angle θ is decreased to less than 180° such that the first and second signal-propagation directions 1552 and 1554 are partially forward (toward the front 1512 of the 3D-MMU package 1500) and not completely horizontal (such as not parallel to the y-axis and not orthogonal to the sides 1518-1519). In a different case in which angles β3 and β4 are decreased to be parallel to the vertical plane (β3=β4=0), the variable-facing angle ↓ is 180° such that the first and second signal-propagation directions 1552 and 1554 are completely horizontal (such as parallel to the y-axis and orthogonal to the sides 1518-1519).

Each of the two front-end circuits 1530 and 1532 includes a filter 1534, 1536 attached to the non-conductive sides of the PCBs 1540 and 1542. In a vertical plane (such as the y-z plane), the filter 1534, 1536 is coplanar with the corresponding TRP antenna board 1520, 1522, as the front end of the filter is closer to the front 1512 of the housing 1510 than the rear end of the corresponding TRP antenna board 1520, 1522.

The 3D-MMU package 1500 of FIG. 15 is attached to a reinforcement structure, such as the reinforcement structure 720, 1600, or 1700 of FIGS. 7, 16, and 1700. The reinforcement structure includes lower and upper mounting clamps 1524 that extend a distance d5 from a horizontal phase bar to the rear 1514.

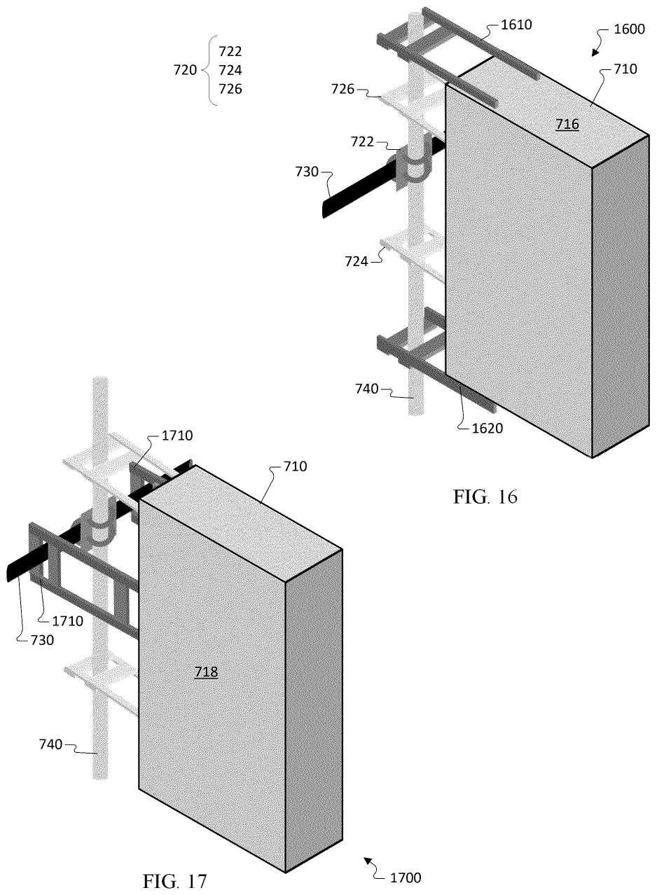

FIG. 16 illustrates a reinforcement structure 1600 that includes an upper reinforcement beam 1610 and a lower reinforcement beam 1620 respectively attached to a top 716 and a bottom end of the multi-dimensional MMU package 710 of FIG. 7 according to this disclosure. The embodiment of the reinforcement structure 1600 shown in FIG. 16 is for illustration only, and other embodiments could be used without departing from the scope of this disclosure. The reinforcement structure 1600 can include the reinforcement structure 720 of FIG. 7.

In some embodiments, a strong support from the bottom face of the package 710 (FIG. 7) is needed in order from the package 710 to be sturdily mounted to the communication cell tower, but the mounting clamps 722, 724, and 726 might not provide a strong support from the bottom end of the package 710. This reinforcement structure 1600 delivers additional structural support from the bottom of the package 710 so that the package 710 is tightly held on to vertical pole 740. Note that one or multiple such beams can be used in the reinforcement structure 1600.

The upper reinforcement beam 1610 is attached a top end 716 of the package 710 and is attached to or configured to attach to the vertical pole 740. The upper reinforcement beam 1610 holds the vertical pole 740 and extends horizontally to the top end of the package 710.

The lower reinforcement beam 1620 is attached a bottom end of the package 710 and is attached to or configured to attach to the vertical pole 740. The lower reinforcement beam 1620 holds the vertical pole 740 and extends horizontally to the bottom end of package 710.

FIG. 17 illustrates a reinforcement structure 1700 that includes one or more side reinforcement beam 1710 attached to a rear of the multi-dimensional MMU package 710 of FIG. 7 according to this disclosure. The embodiment of the reinforcement structure 1700 shown in FIG. 17 is for illustration only, and other embodiments could be used without departing from the scope of this disclosure. The reinforcement structure 1700 can include the reinforcement structure 720 of FIG. 7, the reinforcement structure 1600 of FIG. 16, or both 720 and 1600.

In the example shown, the reinforcement structure 1700 includes two side reinforcement beams 1710 attached to a rear of the package 710. Note that one or multiple such side reinforcement beams 1710 can be jointly employed. Each side reinforcement beam 1710 is attached to or configured to attach to the horizontal pipe 730, which is positioned facing the rear of the package 710 and positioned orthogonal to the opposite sides 718 of the package 710. Each side reinforcement beam 1710 grasps the horizontal pipe 730 and extends horizontally to the rear end of package 710. Unlike the lower and upper mounting clamps 724 and 726 that connect to the vertical pole 740 and rely on the holding power for vertical support, this side reinforcement beam 1710 is a structure that is mainly attached to horizontal pipe 730 and provides additional yet orthogonal support from the bottom of the package 710.

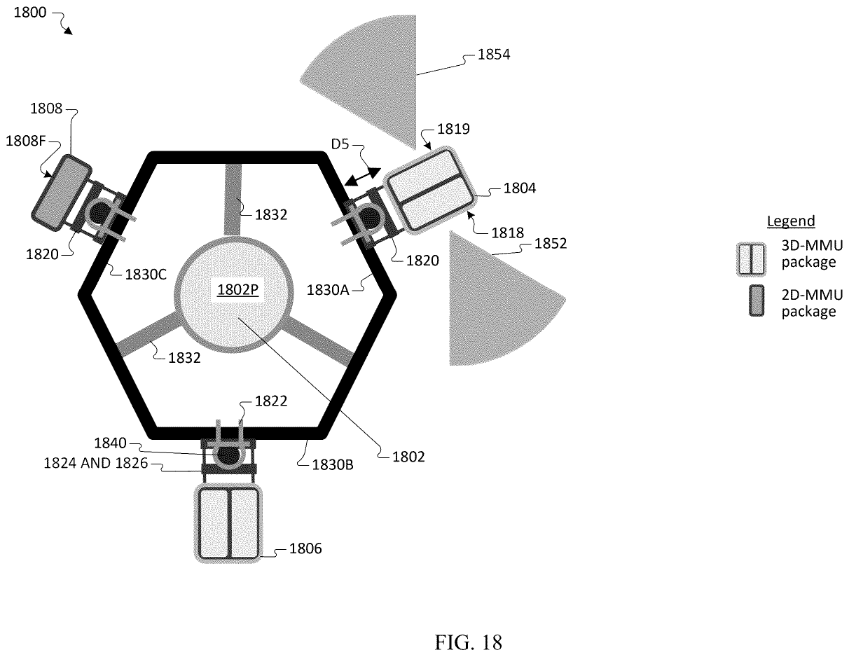

FIG. 18 illustrates a pole tower cell site 1802 and an example deployment 1800 of three MMUs including two 3D-MMUs 1804 and 1806 and one 2D-MMU 1808 according to this disclosure. The embodiment of the deployment 1800 at the pole tower cell site 1802 shown in FIG. 18 is for illustration only, and other embodiments could be used without departing from the scope of this disclosure.

The pole tower cell site 1802 is a site that deploys one MMU at each face. Each of the two 3D-MMUs 1804 and 1806 can represent the 3D-MMU 700 of FIG. 7. The 2D-MMU 1808 can represent the 2D-MMU 610 of FIG. 6A or 900 of FIG. 9. The first side 1818 and second side 1819 of the 3D-MMU 1804 can represent the first side 718 of FIG. 7 and its opposite second side, such as the second side 1519 of FIG. 15. The communication sites 1830A-1830C (1830) are among the structural components of the pole tower cell site 1802, and the communication sites 1830a-1830c can represent the horizontal pipe 730 of FIG. 7. A connecting bar 1832 connects the site platform 1802P to the hexagon of horizontal pipes. The reinforcement structure 1820, first mounting clamp 1822, lower and upper mounting clamps 1824 and 1826, and vertical pole 1840 can represent the corresponding components 720, 722, 724, 726, 740 of FIG. 7. The beams 1852 and 1854 can represent the beams 530 of FIG. 5, or can respectively represent the RF signals 852 and 854 of FIG. 8B. In this example, the beams 1852 and 1854 include a horizontal radiation pattern in which the angles Φ1 and Φ2 are 60°.

In the deployment 1800, multiple 3D-MMU packages are deployed at each communication site 1830 to unlock 3D-MMU cell-layout. The 3D-MMU of this disclosure is compatible with many cell-site options such as pole tower and lattice tower. The 3D-MMU can co-exist with other 2D-MMU packages; however, the mutual interference needs to be handled when considering realistic deployment scenarios. That is, the 2D-MMU package is compatible with 3D-MMU package on the same pole tower cell site 1802. The type of horizontal pipe communication site 1830C to which 2D-MMU packages attach is the same type of horizontal pipe communication site 1830A-1830B to which 3D-MMU packages attach. The reinforcement structure 1820 can be used to attach the communication site 1830 to the 2D-MMU 1808 or to a 3D-MMU 1804, 1806.

Unlike the 2D-MMU 1808 that emits signals through the front face 1808F, the 3D-MMU 1804, 1806 emits RF signals (as beams 1852 and 1854) through the side 1818, 1819 so that 3D-MMU packages need to maintain a certain distance D5 from the horizontal pipe 1830 to not receive any distortion from structural components. The distance D5 can be an extension length of the mounting clamp of the reinforcement structure 1820, for example, from the horizontal pipe 1830 to the rear face of the housing of the 3D-MMU package 1804.

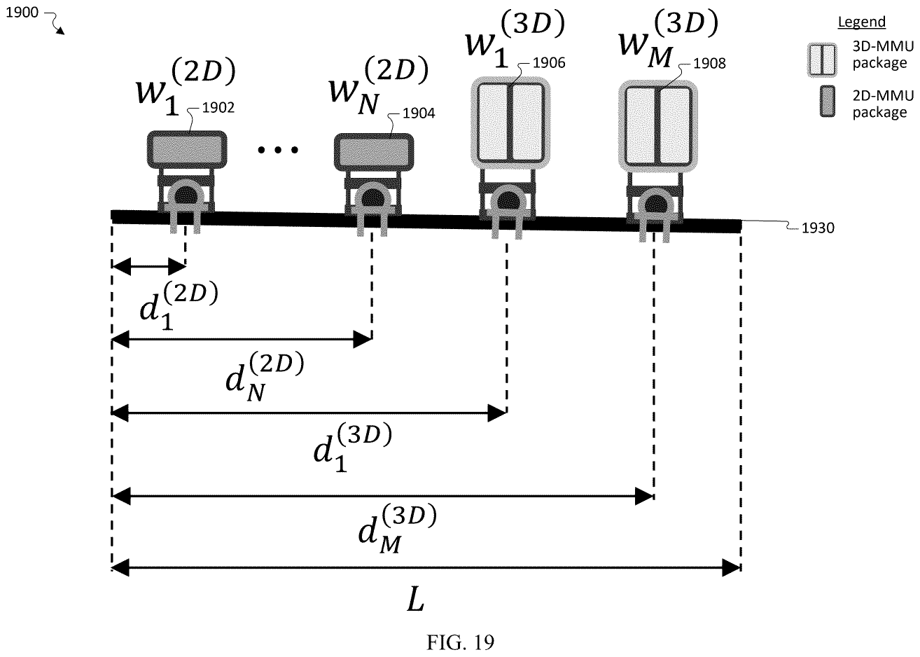

FIG. 19 illustrates a horizontal phase pipe 1930 of a lattice tower cell site and an example deployment 1900 of multiple 2D-MMUs and multiple 3D-MMUs according to this disclosure. The embodiment of the deployment 1900 at the horizontal phase pipe 1930 is for illustration only, and other embodiments could be used without departing from the scope of this disclosure.

This deployment 1900 scenario uses multiple MMUs 1902, 1904, 1906, and 1908 at each face. As an example, one horizontal pipe 1930 enables deployment of N 2D-MMU packages and M 3D-MMU packages. Given that a connecting bar (such as 1832 of FIG. 18) between the horizontal phase pipe 1930 and site platform is usually located at the center of the horizontal phase pipe, a designer can balance across all MMU packages. From the center point of reference, the designer can evenly distribute the weight of all MMU packages across the entire length of the horizontal phase pipe.

For example,

$${w}_{n}^{( 2 D )} and {d}_{n}^{( 2 D )}$$

denote the weight and distance from the end of horizontal pipe 1930 for the nth 2D-MMU package, where n indexes the N 2D-MMU packages. Denote

$${w}_{m}^{( 3 D )} and {d}_{m}^{( 3 D )}$$

as the weight and distance from the end of horizontal pipe for the mth 3D-MMU package. The set of N 2D-MMU packages correspond to the set of weights

$$\{ {w}_{1}^{( 2 D )} , … , {w}_{N}^{( 2 D )} \} ,$$

and the set of M 3D-MMU packages correspond to the set of weights

$$\{ {w}_{1}^{( 3 D )} , … , {w}_{M}^{( 3 D )} \} .$$

The length of horizontal pipe is denoted as L. The term ϵ denotes the tolerance level considering many factors such as package composition and horizontal tilt. The designer should make sure that the center of gravity is closely aligned with the center of the horizontal pipe by satisfying the following constraint set forth in Equation 1.

$$\vert {\sum }_{n = 1}^{N} ( \frac{L}{2} - {d}_{n}^{( 2 D )} ) {w}_{n}^{( 2 D )} + {\sum }_{m = 1}^{M} ( \frac{L}{2} - {d}_{m}^{( 3 D )} ) {w}_{m}^{( 3 D )} \vert \leq ϵ \qquad ( 1 )$$

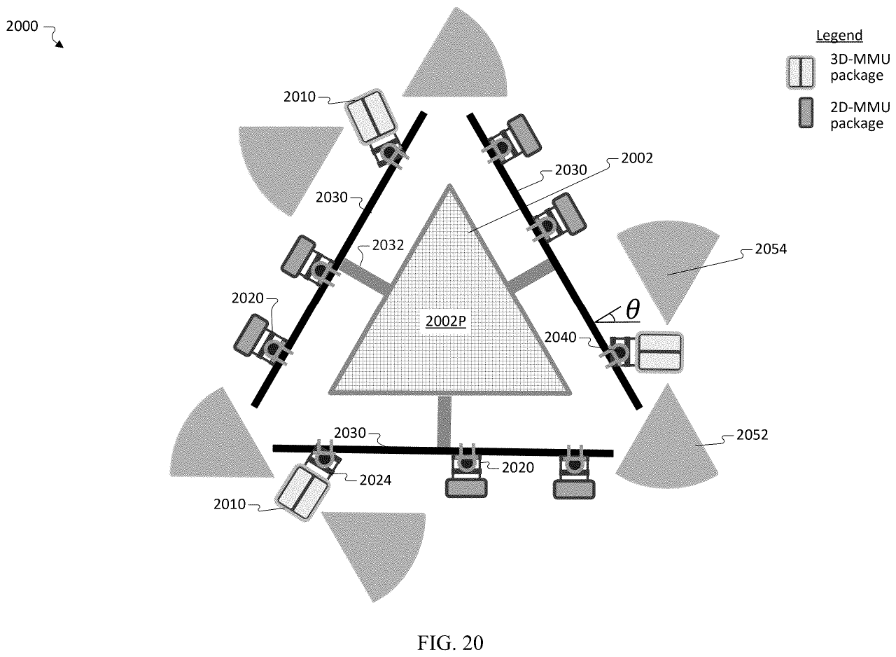

FIG. 20 illustrates a lattice tower cell site 2002 that includes multiple horizontal phase pipes and an example deployment 2000 of a 3D-MMU 2010 attached to a corner region of each of multiple horizontal phase pipes 2030 according to this disclosure. The embodiment of the deployment 2000 at the lattice tower cell site 2002 shown in FIG. 20 is for illustration only, and other embodiments could be used without departing from the scope of this disclosure.

In this deployment 2000, the 3D-MMU 2010 package is positioned near the corner of each horizontal phase pipe 2030. The connecting bars 2032 respectively connect the site platform 2002P to the horizontal phase pipes 2030. In light of the fact that each MMU has a certain half-power beamwidth with a significant amount of power, it is shown that the 3D-MMU 2010 is specified to be installed at a slant angle θ to mounting clamps 2024 so as not to cause any undesirable interference to other MMUs (2D-MMUs) attached to the same horizontal pipe as the 3D-MMU 2010. That is, the lower and upper mounting clamps 2024, which are attached to the vertical pole 2040, form the slant angle θ with respect to the horizontal phase pipe 2030. The slant angle is a non-perpendicular angle of the mounting clamp to prevent the beams 2052 and 2054 from impinging on the phase pipe 2030. As a comparison, the horizontal phase pipe 2030 is perpendicular to the mounting clamp of the reinforcement structure 2020 that attaches the 2D-MMUs.

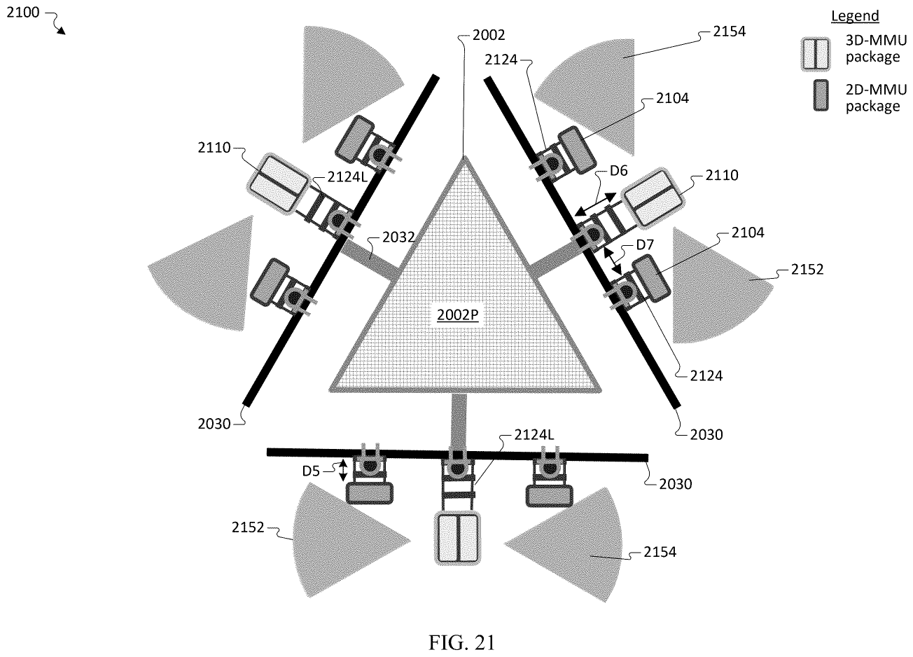

FIG. 21 illustrates a lattice tower cell site that includes multiple horizontal phase pipes and an example deployment 2100 of a 3D-MMU 2110 attached to a middle of each of multiple horizontal phase pipes according to this disclosure. The embodiment of the deployment 2100 at the lattice tower cell site shown in FIG. 21 is for illustration only, and other embodiments could be used without departing from the scope of this disclosure.

The lattice tower cell site shown in FIG. 21 can be the same lattice tower cell site 2002, including structural components 2030 and 2032 of FIG. 20.

The 3D-MMU deployment 2100 scenario at this lattice tower deploys multiple MMUs at each face. In particular, this deployment 2100 shows a scenario when a 3D-MMU package 2110 is located in the middle of each horizontal pipe 2030. Given that each MMU has a certain half-power beamwidth, and given that the 3D-MMU 2110 is bidirectional, it is advantageous to minimize interference to neighboring 2D-MMUs 2104 attached to the same horizontal pipe 2030 on both sides of the 3D-MMU. To this end, the reinforcement structure of the 3D-MMU 2110 includes a longer mounting clamp 2124 to make sure that its signals 2152 and 2154 are not blocked by adjacent 2D-MMUs 2104. That is, the length D6 of the longer mounting clamp 2124L is greater than the distance D5 that another mounting clamp 2124 extends from the horizontal pipe 2030. The mounting claim 2124 associated with the 2D-MMUs 2104 can extend the same distance D5 as the mounting clamp 1820 of FIG. 18 or the mounting claim 2024 of FIG. 20.

In some cases, it is also possible to move the 2D-MMU 2104 a closer distance D7 to the 3D-MMU 2110 so that 2D-MMUs 2104 do not fall under the half-power beamwidth of 3D-MMU such that the beams 2152 and 2154 do not impinge upon structural components of an adjacent 2D-MMUs 2104. For example, the distance D7 can be less than the separation distance from

$${d}_{n}^{( 2 D )} to {d}_{1}^{( 3 D )} ,$$

as shown between the nth 2D-MMU adjacent to the first 3D-MMU that are spaced according to even weight distribution in FIG. 19.

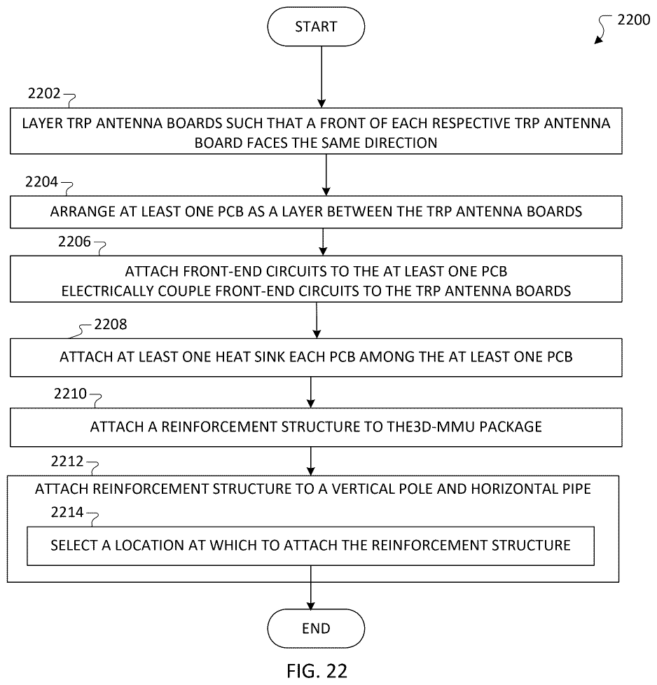

FIG. 22 illustrates a method 2200 for making and deploying a densified multi-dimensional MMU package according to this disclosure. The embodiment of the method 2200 shown in FIG. 22 is for illustration only, and other embodiments could be used without departing from the scope of this disclosure. The method 2200 is described as though the multi-dimensional MMU package is part of the system 700 of FIGS. 7 and 8.

At block 2202, TRP antenna boards 820 and 822 are layered such that a front of each respective TRP antenna board faces the same direction.

At block 2204, at least one printed circuit board (PCB) is arranged as a layer between the TRP antenna boards 820 and 822 such that the at least one PCB includes multiple antenna-facing sides. For example, the multiple antenna-facing sides in FIG. 10 include the conductive sides of the two PCBs 1040 and 1042. In some embodiments, block 2204 includes attaching the TRP antenna boards to the multiple antenna-facing sides, respectively.

At block 2206, front-end circuits 830 and 832 are attached to the at least one PCB. For example, the front-end circuits 830 and 832 are attached to the antenna-facing sides of the at least one PCB 840 of FIG. 8, and the front-end circuits 1130 and 1132 are attached to the antenna-facing sides of the double-sided PCB 1140 of FIG. 11. As another example, the front-end circuits 1030 and 1032 are attached to the non-conductive sides of the single-sided PCBs 1040 and 1042 of FIG. 10.

Also, at block 2206, front-end circuits 830 and 832 are electrically coupled to the TRP antenna boards, respectively. For example, a second side of the TRP antenna boards 820 and 822 are electrically coupled to and physically attached to the antenna-facing sides of the front-end circuits 830 and 832, as shown in FIG. 8. As another example, the conductive side of the antenna board 1140 is electrically coupled to and attached to the TRP antenna boards 1120 and 1122 and the front-end circuits 1130 and 1132, as shown in FIG. 11.

At block 2208, at least one heat sink 1060 is attached to each PCB among the at least one PCB 1040 and 1042.

At block 2210, a reinforcement structure 720 is attached to the multi-dimensional MMU package 710. For example, at least one mounting clamp 1524 is attached to a rear 1514 of a housing 1510 of the 3D-MMU package 1500 of FIG. 15. Additionally, a first mounting clamp 1822 attaches to a vertical pole 1840, and the first mounting clamp 1822 is positioned adjacent to the rear of the TRP antenna boards that are housed within the 3D-MMU 1804, 1806, as shown in FIG. 18.

At block 2212, the reinforcement structure 720 attaches to a vertical pole 740 and horizontal pipe 730 that can be attached to (or part of) a platform of a communication cell tower.

In some embodiments, attaching the reinforcement structure 720 to the vertical pole and horizontal pipe includes selecting a location at which to attach the reinforcement structure. At block 2214, the location on the horizontal pipe 730 where the multi-dimensional MMU package 710 with its reinforcement structure 720 is attached is selected. In some embodiments, the location is selected to balance weight along the length L of the horizontal pipe, or to align the center of gravity with the center of the length L of the horizontal pipe, as shown in FIG. 20. In some embodiments, the location is selected based on a closer distance D7 that prevents the half-power beamwidth of the beams 2152 and 2154 emitted from a 3D-MMU from impinging upon structural components of an adjacent 2D-MMUs 2104, as shown in FIG. 21.

Although FIG. 22 illustrates an example method 2200 for deploying a densified multi-dimensional MMU package, various changes may be made to FIG. 22. For example, while shown as a series of steps, various steps in FIG. 22 could overlap, occur in parallel, occur in a different order, or occur any number of times. As a particular example, in some embodiments, the method 2200 further includes selecting a distance D5 or D6 as an extension length of the lower and upper mounting clamps 1824, 1826 2124L, as shown in FIG. 18 and FIG. 21. In some embodiments, the method 2200 includes selecting a slant angle θ of mounting clamps 2024 relative to a horizontal pipe 2030, based on proximity to other MMUs (2D-MMUs) attached to the same horizontal pipe, as shown in FIG. 20.

The above flowchart illustrates an example method that can be implemented in accordance with the principles of the present disclosure and various changes could be made to the method illustrated in the flowchart herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An apparatus comprising:
transmit receive point (TRP) antenna boards layered such that a front of each respective TRP antenna board faces the same direction;
at least one printed circuit board (PCB) including multiple antenna-facing sides on which the TRP antenna boards are attached, respectively; and
front-end circuits that are attached to the at least one PCB and that are electrically coupled to the TRP antenna boards, respectively,
wherein each of the TRP antenna boards includes:
a rear that is opposite to the front,
a signal-propagation side that includes a two-dimensional (2D) multiple-input multiple-output (MIMO) antenna array and extends from the front to the rear, and
a second side that faces toward the at least one PCB, is opposite to the signal-propagation side, and extends from the front to the rear.

2. The apparatus of claim 1, wherein:
the at least one PCB includes one double-sided PCB attached to the TRP antenna boards on opposite sides of the PCB;
each of the front-end circuits includes:
a power amplifier positioned between the TRP antenna boards and one from among a top end and a bottom end of the PCB; and
a filter positioned between the TRP antenna boards and the other from among the top end and the bottom end of the PCB; and
the double-sided PCB is layered between the front-end circuits.

3. The apparatus of claim 1, wherein:
the at least one PCB includes two single-sided PCBs that each includes a different one of the multiple antenna-facing sides opposite to a non-conductive side of the PCB; and
the front-end circuits include two front-end circuits attached to the two single-sided PCBs, respectively.

4. The apparatus of claim 3, wherein:
the two front-end circuits are attached to the non-conductive side of the two single-sided PCBs, respectively, and
each respective front-end circuit includes a front-end board, a filter, and a power amplifier.

5. The apparatus of claim 3, further comprising:
a rotating gear configured to control a down-tilt angle of each of the TRP antenna boards, including to rotate in a clockwise direction to increase a separation distance between top ends of the two single-sided PCBs, and to rotate in a counterclockwise direction to decrease the separation distance
a pivot joint attached to the non-conductive side of each of the two single-sided PCBs, and configured to decrease a second separation distance between bottom ends of the two single-sided PCBs while the separation distance between the top ends of the two single-sided PCBs increases.

6. The apparatus of claim 3, further comprising:
a rotating gear configured to control a variable-facing angle of each of the TRP antenna boards, including to rotate in a clockwise direction to increase a separation distance between rear ends of the two single-sided PCBs, and to rotate in a counterclockwise direction to decrease the separation distance; and
a pivot joint attached to the non-conductive side of each of the two single-sided PCBs, and configured to decrease a second separation distance between front-end s of the two single-sided PCBs while the separation distance between the rear ends of the two single-sided PCBs increases.

7. The apparatus of claim 1, wherein the respective TRP antenna board includes:
rows of TRP antennas within the 2D MIMO antenna array; and
connecting wires that extend from the rows of TRP antennas, respectively, to the antenna-facing side of the PCB to which the respective TRP antenna board is attached; and
wherein the connecting wires extend proportional distances such that the rows of TRP antennas form a down-tilt angle of the respective TRP antenna board.

8. The apparatus of claim 7, wherein:
the front-end circuits are respectively attached to the antenna-facing sides of the at least one PCB; and
each of the front-end circuits includes:
a power amplifier positioned between the TRP antenna boards and one from among a top end and a bottom end of the PCB; and
a filter positioned between the TRP antenna boards and the other from among the top end and the bottom end of the PCB.

9. The apparatus of claim 1, further comprising a reinforcement structure that includes:
at least one mounting clamp attached to a rear of the apparatus and configured to attach to a vertical pole positioned adjacent to the rear of the TRP antenna boards.

10. The apparatus of claim 1, further comprising a reinforcement structure that includes at least one of:
an upper reinforcement beam attached a top end of the apparatus and configured to attach to a vertical pole; or
a lower reinforcement beam attached a bottom end of the apparatus and configured to attach to the vertical pole.

11. The apparatus of claim 1, further comprising a reinforcement structure that includes:
at least one side reinforcement beam attached to a rear of the apparatus and configured to attach to a horizontal pole positioned adjacent to the rear of the TRP antenna boards and positioned orthogonal to the opposite sides of the TRP antenna boards.

12. The apparatus of claim 1, further comprising a reinforcement structure configured to attach to a pole tower while a 2D massive MIMO unit attached to the pole tower.

13. The apparatus of claim 1, further comprising a reinforcement structure configured to attach to a corner region of a horizontal phase pipe of a lattice tower while a 2D massive MIMO unit is attached to the horizontal phase pipe,
wherein a slant angle of the reinforcement structure with respect to the horizontal phase pipe is non-parallel and non-orthogonal.

14. The apparatus of claim 1, further comprising a reinforcement structure configured to attach to a middle of a horizontal phase pipe of a lattice tower while a 2D massive MIMO unit (MMU) is attached to a corner region of the horizontal phase pipe,
wherein a length of the reinforcement structure orthogonally extends from the horizontal phase pipe farther than the 2D MMU.

15. A system comprising:
an antenna package that includes:
transmit receive point (TRP) antenna boards layered such that a front of each respective TRP antenna board faces the same direction;
at least one printed circuit board (PCB) including multiple antenna-facing sides on which the TRP antenna boards are attached, respectively;
front-end circuits that are attached to the at least one PCB and that are electrically coupled to the TRP antenna boards, respectively; and
at least one heat sink attached to the at least one PCB;
wherein each of the TRP antenna boards includes:
a rear that is opposite to the front,
a signal-propagation side that includes a two-dimensional (2D) multiple-input multiple-output (MIMO) antenna array and extends from the front to the rear, and
a second side that faces toward the at least one PCB, is opposite to the signal-propagation side, and extends from the front to the rear; and
a reinforcement structure that includes at least one mounting clamp attached to a rear of the package and configured to attach to a vertical pole positioned adjacent to the rear of the TRP antenna boards.

16. The system of claim 15, wherein:
the at least one PCB includes two single-sided PCBs that each includes a different one of the multiple antenna-facing sides opposite to a non-conductive side of the PCB;
the front-end circuits include two front-end circuits attached to the non-conductive side of the two single-sided PCBs, respectively; and
each respective front-end circuit includes a front-end board, a filter, and a power amplifier.

17. The system of claim 15, wherein:
the front-end circuits are respectively attached to the antenna-facing sides of the at least one PCB;
each of the front-end circuits includes:
a power amplifier positioned between the TRP antenna boards and one from among a top end and a bottom end of the PCB; and
a filter positioned between the TRP antenna boards and the other from among the top end and the bottom end of the PCB; and
the respective TRP antenna board includes:
rows of TRP antennas within the 2D MIMO antenna array; and
connecting wires that extend from the rows of TRP antennas, respectively, to the antenna-facing side of the PCB to which the respective TRP antenna board is attached; and
the connecting wires extend proportional distances such that the rows of TRP antennas form a down-tilt angle of the respective TRP antenna board.

18. The system of claim 15, further comprising a reinforcement structure that includes at least one of:
an upper reinforcement beam attached a top end of the package and configured to attach to a vertical pole;
a lower reinforcement beam attached a bottom end of the package and configured to attach to the vertical pole; and
at least one side reinforcement beam attached to a rear of the package and configured to attach to a horizontal pole positioned adjacent to the rear of the TRP antenna boards and positioned orthogonal to the opposite sides of the TRP antenna boards.

19. The system of claim 15, further comprising a reinforcement structure configured to attach to a corner region of a horizontal phase pipe of a lattice tower while a 2D massive MIMO unit is attached to the horizontal phase pipe,
wherein a slant angle of the reinforcement structure with respect to the horizontal phase pipe is non-parallel and non-orthogonal.

20. The system of claim 15, further comprising a reinforcement structure configured to attach to a middle of a horizontal phase pipe of a lattice tower while a 2D massive MIMO unit (MMU) is attached to a corner region of the horizontal phase pipe,
wherein a length of the reinforcement structure orthogonally extends from the horizontal phase pipe farther than the 2D MMU.
